(19) United States
(12) Patent Application Publication
(10) Pub. No.: US 2026/0029686 A1
(43) Pub. Date: Jan. 29, 2026

(54) HIGH SPEED OPTICAL NEURAL NETWORK HARDWARE ACCELERATOR USING ADIABATIC ELIMINATION-BASED ITO OPTICAL LOGIC GATES

(71) Applicant: University of Florida Research Foundation, Incorporated, Gainesville, FL (US)

(72) Inventors: Hamed Dalir, Gainesville, FL (US); Elham Heidari, Gainesville, FL (US); Navid Asadi-Zanjani, Gainesville, FL (US); Chandraman Patil, Gainesville, FL (US); Jiachi Ye, Gainesville, FL (US); Belal Jahannia, Gainesville, FL (US); Qian Cai, Gainesville, FL (US)

(21) Appl. No.: 19/273,647

(22) Filed: Jul. 18, 2025

Related U.S. Application Data
(60) Provisional application No. 63/675,032, filed on Jul. 24, 2024.

(51) Int. Cl. G02F 3/00

(52) U.S. Cl. CPC G02F 3/00

(57) ABSTRACT

A photonic gate system comprising a center waveguide that is provided with a continuous wave input; a first electrically controlled plasmonic waveguide configured on a first opposing side that is adjacent to the center waveguide; a second electrically controlled plasmonic waveguide configured on a second opposing side that is adjacent to the center waveguide; a first outer waveguide configured adjacent to the first electrically controlled plasmonic waveguide; and a second outer waveguide configured adjacent to the second electrically controlled plasmonic waveguide.

### CROSS REFERENCE TO RELATED APPLICATION

This application claims the priority of U.S. Provisional Application No. 63/675,032, entitled “HIGH SPEED OPTICAL NEURAL NETWORK HARDWARE ACCELERATOR USING ADIABATIC ELIMINATION-BASED ITO OPTICAL LOGIC GATES,” filed on Jul. 24, 2024, the disclosure of which is hereby incorporated by reference in its entirety.

### BACKGROUND

Photonic integrated circuits (PICs) may provide an alternative to traditional electronic systems by offering higher bandwidth, lower power consumption, and reduced latency. Photonic logic gates (PLGs), that form the building blocks of logical array PICs, may operate at higher bandwidths than electronic gates. Accordingly, high-speed optical logic gates may improve PICs and address electronic system limitations.

### BRIEF SUMMARY

Various embodiments described herein relate to a photonic gate system. According to some embodiments, the photonic gate system comprises a center waveguide that is provided with a continuous wave input; a first electrically controlled plasmonic waveguide configured on a first opposing side that is adjacent to the center waveguide; a second electrically controlled plasmonic waveguide configured on a second opposing side that is adjacent to the center waveguide; a first outer waveguide configured adjacent to the first electrically controlled plasmonic waveguide; and a second outer waveguide configured adjacent to the second electrically controlled plasmonic waveguide.

In some embodiments, the first electrically controlled plasmonic waveguide is configured to receive a first signal input and the second electrically controlled plasmonic waveguide is configured to receive a second signal input. In some embodiments, the first outer waveguide is configured to provide a first output that corresponds to the first signal input and the second outer waveguide is configured to provide a second output that corresponds to the second signal input. In some embodiments, the photonic gate system further comprises a coupler that is coupled to the first outer waveguide and the second outer waveguide. In some embodiments, the coupler is configured to generate a data signal output based on (i) a first output that corresponds to the first outer waveguide and (ii) a second output that corresponds to the second outer waveguide. In some embodiments, the data signal output comprises a matrix multiplication result output corresponding to a processing element of a systolic array. In some embodiments, the first electrically controlled plasmonic waveguide and the second electrically controlled plasmonic waveguide further comprise indium tin oxide or silicon dioxide that is coupled with gold or titanium padding. In some embodiments, a wavelength of the continuous wave input is configured to control coupling between (i) the first electrically controlled plasmonic waveguide and a first outer waveguide or the (ii) the second electrically controlled plasmonic waveguide and the second outer waveguide. In some embodiments, the continuous wave input comprises a wavelength that corresponds to a logic gate operation. In some embodiments, the logic gate operation comprises AND, NAND, NOR, OR, XOR, or XNOR.

### BRIEF DESCRIPTION OF THE DRAWINGS

Embodiments incorporating teachings of the present disclosure are shown and described with respect to the figures presented herein.

FIG. 1 depicts an example overview of an architecture in accordance with some embodiments of the present disclosure.

FIG. 2 depicts an example computing entity in accordance with some embodiments of the present disclosure.

FIG. 3 depicts an example client computing entity in accordance with some embodiments of the present disclosure.

FIG. 4 is a diagram of an example photonic gate system in accordance with some embodiments of the present disclosure.

FIG. 5 are example input and output signals of an example photonic OR gate implementation in accordance with some embodiments of the present disclosure.

FIGS. 6A through 6D are AE schemes depicted in atomic physics and optical waveguides for an example OR gate.

FIGS. 7A through 7D are diagrams of an example XNOR photonic logic gate (PLG) in accordance with some embodiments of the present disclosure.

FIG. 8 example input and output signals of an example XNOR PLG implementation in accordance with some embodiments of the present disclosure.

FIG. 9 are example input and output signals of an example NOR PLG implementation in accordance with some embodiments of the present disclosure.

FIG. 10 are example input and output signals of an example NAND PLG implementation in accordance with some embodiments of the present disclosure.

FIG. 11 are example input and output signals of an example XOR PLG implementation in accordance with some embodiments of the present disclosure.

FIG. 12 are example input and output signals of an example AND PLG implementation in accordance with some embodiments of the present disclosure.

FIG. 13 is a schematic diagram of an example systolic array in accordance with some embodiments of the present disclosure.

FIG. 14 is an architectural and layer information diagram for an example XNOR-Net neural network.

FIG. 15 is a comparison of example components for realizing a XNOR-Net in electronic and photonic domains in accordance with some embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

The present disclosure provides an indium tin oxide (ITO)-based photonic logic gate (PLG) design that leverages free carrier modulation and terahertz (THz) operation speed of ITO-based PLGs and incorporates adiabatic elimination (AE) principles to create highly efficient, compact, and high-speed logic gates for photonic artificial intelligent computing systems and ultra-dense integrated photonic circuits. Using ITO-based PLG with AE operation principle in a three-coupled waveguide system may allow for effective switching of signal between waveguides by controlling the effective refractive index. Such an approach may significantly boost modulation efficiency and reduce device footprint. In some embodiments, an adiabatically coupled waveguide (ACW) is used to implement an XNOR-Net to improve performance via faster processing and reduced power consumption compared to state-of-the-art counterparts. In some embodiments, an ITO-based multifunctional PLG comprises functionality that (i) corresponds to a logic gate of a plurality of logic gates and (ii) is configurable to any one of the plurality of logic gates by configuring a continuous wave (CW) wavelength that is used to control coupling between plasmonic and outer waveguides. Accordingly, the disclosed ITO-based PLG may provide a highly efficient, compact, and high-speed logic gate for next-generation photonic computing and ultra-dense integrated photonic circuits.

### Example Technical Implementation of Various Embodiments

Embodiments of the present disclosure may be implemented in various ways, including as hardware-based optical computing devices, as well as in combination with computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable storage media (including volatile and non-volatile media).

A non-volatile computer-readable storage medium may include one or more magnetic and/or electro-mechanical storage devices, such as floppy disk(s), hard disk(s), magnetic tape, punch card(s), paper tape(s), optical mark sheet(s) (or any other physical medium with patterns of holes or other optically or mechanically detectable indicia), any other non-transitory magnetic medium, and/or the like. A non-volatile computer-readable storage medium may additionally or alternatively include one or more optical storage devices, such as compact disc read only memory (CD-ROM), compact disc-rewritable (CD-RW), any other non-transitory optical medium, and/or the like. A non-volatile computer-readable storage medium may additionally or alternatively include one or more read-only memory (ROM); programmable read-only memory (PROM); crasable programmable read-only memory (EPROM); electrically erasable programmable read-only memory (EEPROM), such as flash memory; and/or the like. In some examples, flash memory may comprise a set of field effect transistors and/or other devices or circuitry that implement serial and/or parallel NAND, NOR, and/or other hardware logic for storing data. In some examples, solid state storage (SSS), such as a solid state drive (SSD), flash drive, solid-state hybrid drives (SSHDs), and/or the like may include flash memory (SSHDs are a hybrid device that may include a hard disk and flash memory in some examples); and, in some examples, flash memory may be used as cache memory, implemented as a basic input output system (BIOS) chip or part of a BIOS chip, and/or the like. A non-volatile computer-readable storage medium may additionally or alternatively include 3D XPoint memory, non-volatile random access memory (NVRAM) (e.g., bridging random access memory (CBRAM), phase-change random access memory (PRAM), magnetoresistive random-access memory (MRAM), ferroelectric random-access memory (FeRAM)), racetrack memory, and/or the like. A non-volatile computer-readable storage medium may additionally or alternatively include one or more thermo-mechanical storage devices, such as Millipede memory; one or more molecular memory repositories; and/or the like.

A volatile computer-readable storage medium may include random access memory (RAM), dynamic random access memory (DRAM), static random access memory (SRAM), synchronous dynamic random access memory (SDRAM), cache memory (including various levels), register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps including in embodiments incorporating optical logic gates, photonic computing elements, and hybrid optical-electronic platforms.

### Example System Architecture

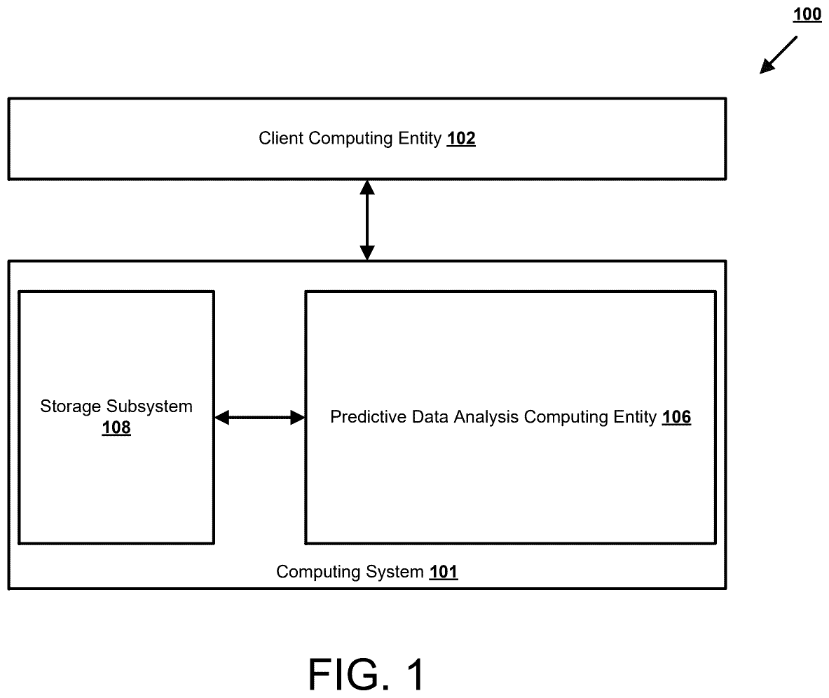

FIG. 1 depicts an example overview of an architecture 100 in accordance with some embodiments of the present disclosure. The platform 100 may comprise or interface with high-speed optical neural network accelerators based on adiabatic elimination principles, utilizing integrated indium tin oxide (ITO) optical logic gate arrays to perform computationally intensive neural operations with high energy efficiency and reduced latency. The architecture 100 includes a computing system 101 configured to receive input data from client computing entity 102, process the input data to generate output data, and provide the output data to the client computing entity 102. In some embodiments, the input data may be processed through optical logic operations to perform neural network computations, such as weighted matrix multiplications and activation functions. Processed output data may then be transmitted back from computing system 101 to client computing entity 102 or stored by storage subsystem 108.

In some embodiments, computing system 101 may communicate with at least one of the client computing entity 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like). In some embodiments, the networks may facilitate communication with, control of, or data exchange from optical neural network accelerator systems comprising adiabatic elimination-based ITO optical logic gate arrays.

The computing system 101 may include a predictive data analysis computing entity 106 and a storage subsystem 108. The predictive data analysis computing entity 106 may be configured to receive input data from client computing entity 102, process the input data to generate output data by performing neural network computations, such as weighted matrix multiplications and activation functions, and provide the output data to the client computing entity 102 or stored by storage subsystem 108.

The storage subsystem 108 may be configured to store input data used by the predictive data analysis computing entity 106 to perform neural network computations. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Example Data Analysis Computing Entity

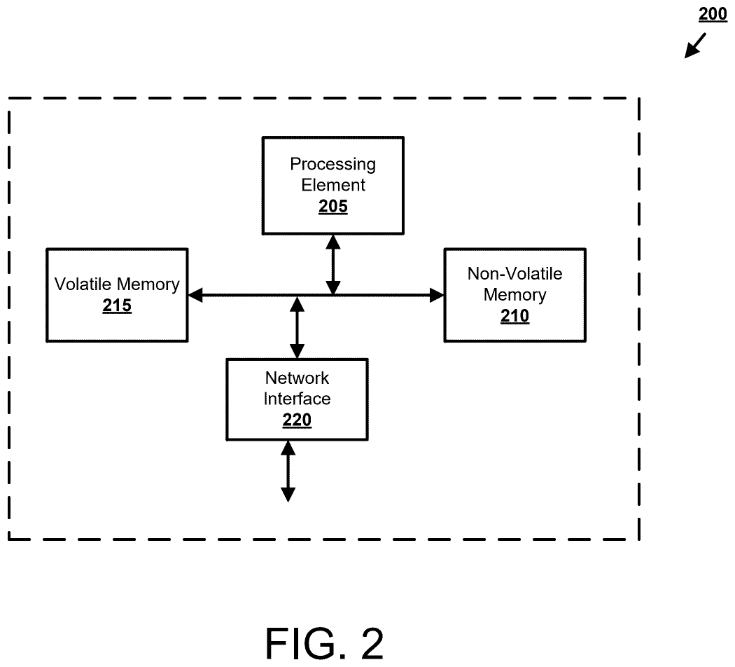

FIG. 2 depicts an example computing entity 200 in accordance with some embodiments of the present disclosure. The computing entity 200 is an example of the predictive data analysis computing entity 106. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably.

As indicated, in one embodiment, the computing entity 200 may also include one or more network interfaces 220 for communicating with various computing entities, such as by communicating data, content, information, and/or similar terms used herein interchangeably that may be transmitted, received, operated on, processed, displayed, stored, and/or the like.

As shown in FIG. 2, in one embodiment, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing elements 205 may be embodied in a number of different ways.

For example, the processing elements 205 may be embodied as one or more complex programmable logic devices (CPLDs), microprocessors, multi-core processors, coprocessing entities, application-specific instruction-set processors (ASIPs), microcontrollers, and/or controllers. Further, the processing elements 205 may be embodied as one or more other processing devices or circuitry. The term circuitry may refer to an entirely hardware embodiment or a combination of hardware and computer program products. Thus, the processing elements 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing elements 205 may be configured for a particular use or configured to execute instructions stored in volatile or non-volatile media or otherwise accessible to the processing elements 205. As such, whether configured by hardware or computer program products, or by a combination thereof, the processing elements 205 may be capable of performing steps or operations according to embodiments of the present disclosure when configured accordingly.

In one embodiment, the computing entity 200 may further include, or be in communication with, non-volatile media (also referred to as non-volatile storage, memory, memory storage, memory circuitry, and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the computing entity 200 may further include, or be in communication with, volatile media (also referred to as volatile storage, memory, memory storage, memory circuitry, and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing elements 205. Thus, the databases, database instances, database management systems, data, applications, programs, program modules, scripts, source code, object code, byte code, compiled code, interpreted code, machine code, executable instructions, and/or the like may be used to control certain aspects of the operation of the computing entity 200 with the assistance of the processing elements 205 and operating system.

As indicated, in one embodiment, the computing entity 200 may also include one or more network interfaces 220 for communicating with various computing entities, such as by communicating data, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 200 may be configured to communicate via wireless external communication networks using any of a variety of protocols, such as new radio (NR), general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### Example Client Computing Entity

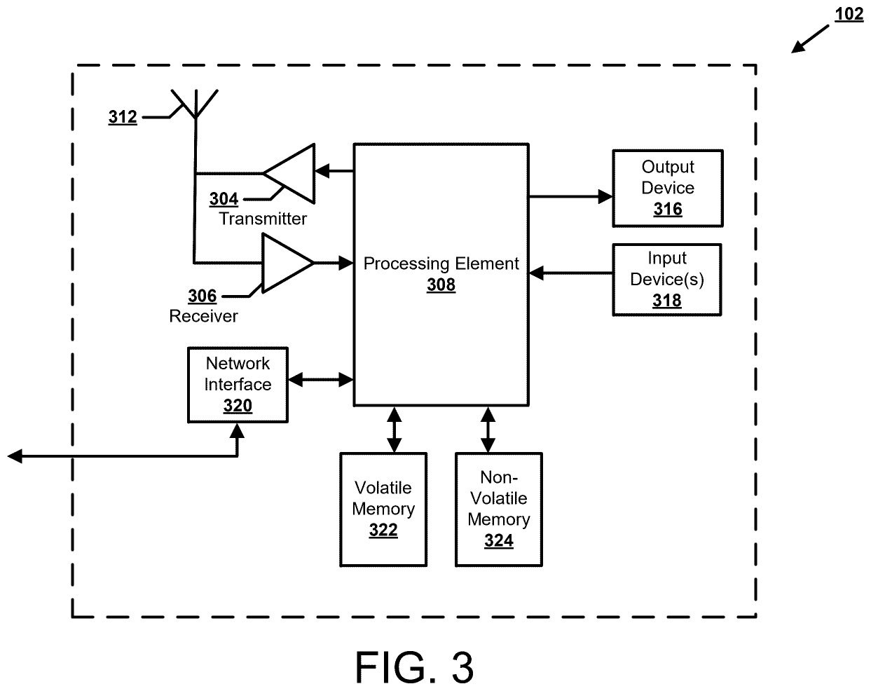

FIG. 3 depicts an example client computing entity 102 in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein.

Client computing entity 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In a particular embodiment, the client computing entity 102 may operate in accordance with multiple wireless communication standards and protocols, such as NR, GPRS, UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile storage or memory 322 and/or non-volatile storage or memory 324, which may be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory may store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionality that are the same or similar to those of the computing entity 200, as described in greater detail above. As will be recognized, these architectures and descriptions are provided for exemplary purposes only and are not limited to the various embodiments.

In various embodiments, the client computing entity 102 may interface with, control, configure, or retrieve results from high-speed optical neural network accelerator systems utilizing adiabatic elimination-based ITO optical logic gate arrays.

### Example Photonic Gate Design

Various embodiments of the present disclosure describe photonic logic gates comprising ACW modulators using ITO.

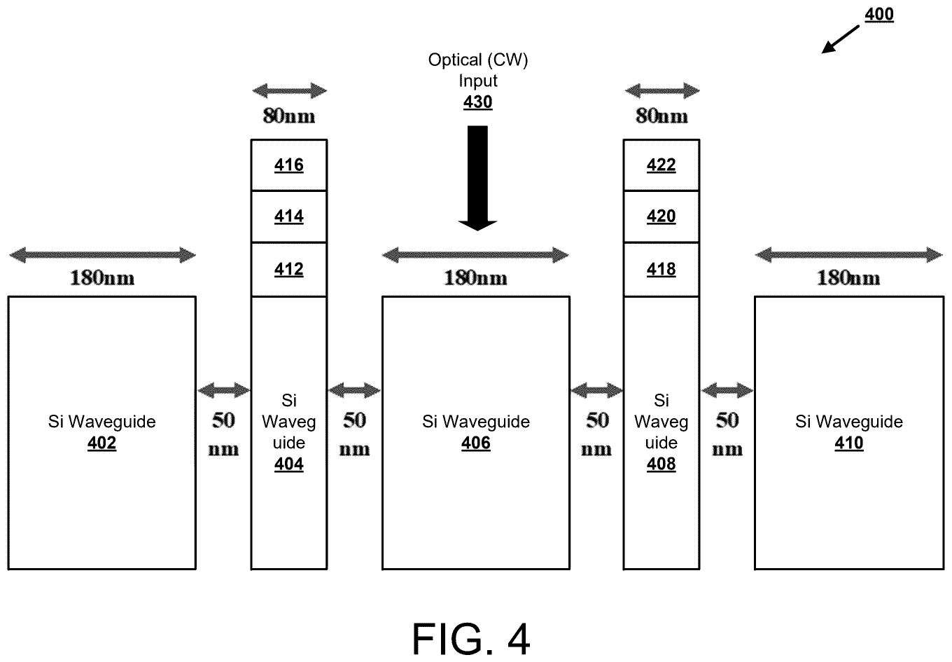

FIG. 4 is a cross-sectional view of an example photonic gate system 400 in accordance with some embodiments of the present disclosure. The photonic gate system 400 is an example of a PLG and comprises five silicon (Si) waveguides 402, 404, 406, 408, and 410. The Si waveguide 406 may form a controllable coupling system with the two adjacent waveguides on each side (e.g., Si waveguides 402, 404 and Si waveguides 408, 410). The Si waveguide 406 may be provided with an optical (e.g., CW) input 430. The Si waveguides 404 and 408 may comprise electrically controlled plasmonic waveguides that are provided with data inputs (e.g., Si waveguide 404 is configured to receive Y input and Si waveguide 408 is configured to receive X input).

Si waveguide 402 is configured adjacent to Si waveguide 404 such that Si waveguide 404 is configured in between Si waveguide 402 and Si waveguide 406. Si waveguide 410 is configured adjacent to Si waveguide 408 such that Si waveguide 408 is configured in between Si waveguide 406 and Si waveguide 410. Si waveguide 402 comprises an outer waveguide that provides an output corresponding to the Y input and Si waveguide 410 comprises an outer waveguide that provides an output corresponding to the X input, where the outputs from the Si waveguide 402 and Si waveguide 410 may be merged through a Y-combiner to provide a data signal output of the photonic gate system 400.

The dimension of Si waveguides 402, 406, and 410 may comprise dimensions of 180×550 nm to transmit transverse magnetic (TM) mode light. The photonic gate system 400 may further comprise, between the Si waveguides 402, 404, 406, 408, and 410, couplers that are 17 μm in length and comprise a gap of 50 nm. The Si waveguides 404 and 408 may comprise dimensions of 80×550 nm and be combined with ITO (e.g., 20 nm) 412, silicon dioxide (SiO₂) (e.g., 40 nm) 414 and ITO (e.g., 20 nm) 418, SiO₂ (e.g., 40 nm) 420, respectively generating plasmonic effect, connected by gold (Au) or titanium (Ti) pads 416 and 422, respectively. Accordingly, the photonic gate system 400 may represent two identical three-coupled mode systems comprising (i) Si waveguides 402, 404, and 406 and (ii) Si waveguides 406, 408, and 410, X and Y controls, with respective coupling coefficients V₁₂, V₂₃, and V₁₃ for X control and V₃₄, V₄₅, and V₃₅ for the Y control.

Adiabatic coupling in PLGs may comprise controlling coupling between respective plasmonic (e.g., Si waveguides 404 or 408) and outer waveguides (e.g., Si waveguides 402 or 410). Optical field propagation in the waveguides is analogous to energy bands in electric system. Various embodiments of the present disclosure may use an electrically driven ITO layer, by changing free carrier concentration to control the effective refractive index resulting in AE conditions when V₂₁>>|Δβ₁₂|, where V₂₁ may represent the coupling strength between waveguides and Δβ₁₂ may represent the propagation constant mismatch. This allows for coupling between external waveguides, expressed as:

$${V}_{eff 1} = {V}_{13} - \frac{{V}_{12} {V}_{23}}{Δ {β}_{21}} \qquad Equation 1$$

$${V}_{eff 2} = {V}_{53} - \frac{{V}_{54} {V}_{43}}{Δ {β}_{45}} . \qquad Equation 2$$

Under AE conditions, the Si waveguide 406 may be lossy with minimal optical interaction, switching the system to an effective two waveguide directional coupler system. Such modulation capability allows the photonic gate system 400 to rapidly switch between AE conditions (OFF state) and non-AE conditions (ON state), for realizing complex logic operations.

For a non-AE condition, the light injected in SI waveguide 406 propagates via all the Si waveguides 402 through 410. When AE conditions are satisfied, the signal in SI waveguide 406 propagates in the outer Si waveguides 402 and 410. The Si waveguide 408 and 404 (X and Y plasmonic waveguides) are effectively transparent to the photonic gate system. This change may directly affect how light signals from SI waveguide 406 are coupled and transmitted to (output) Si waveguides 402 and 410 (e.g., by altering the optical path difference, changing the phase, and/or determining whether signal enters the Y-combiner). As such, the photonic gate system 400 may be used to realize multiple logic gate functions, such as AND, NAND, NOR, OR, XOR, and XNOR, by selecting the CW wavelength and controlling the states of the plasmonic waveguides. The disclosed design may increase the integration density of the photonic gate system 400 and provide modulation control at reduced power consumption.

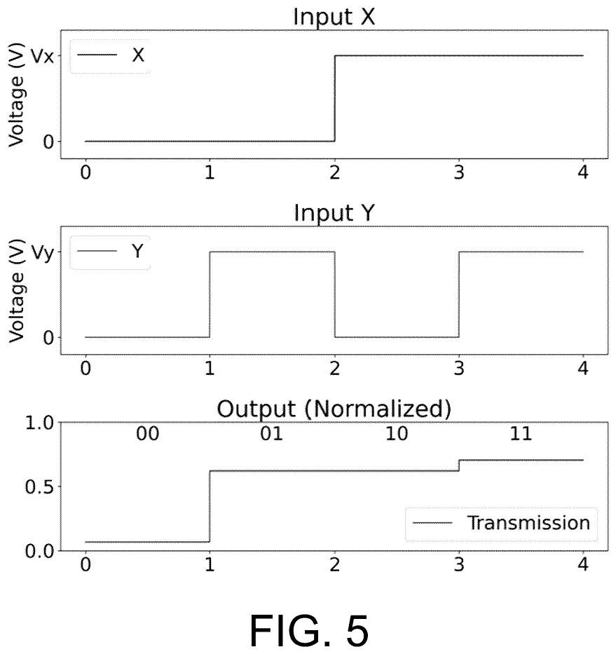

FIG. 5 are example input and output signals of an example photonic OR gate implementation in accordance with some embodiments of the present disclosure.

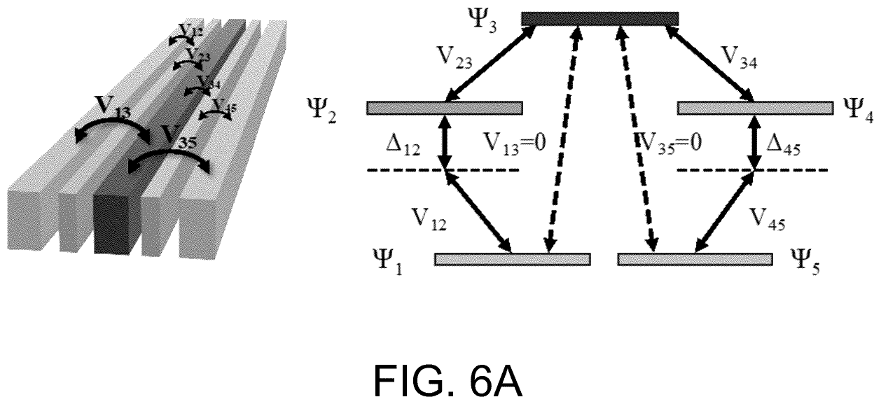

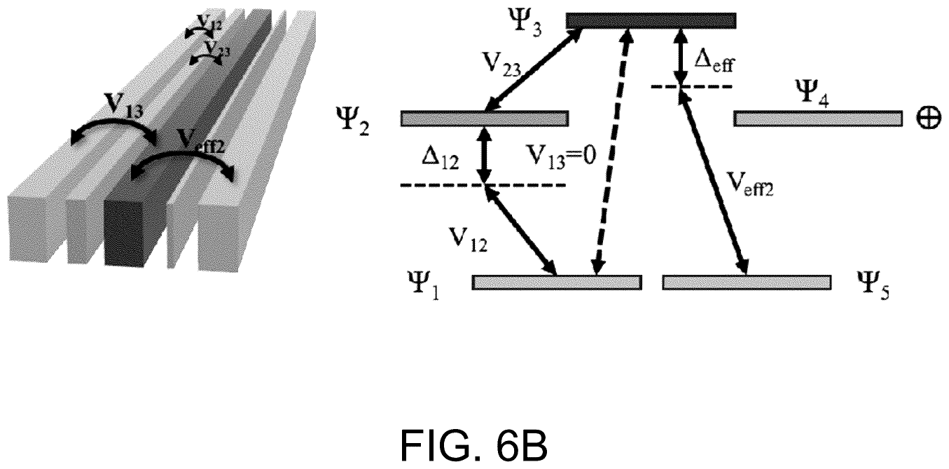

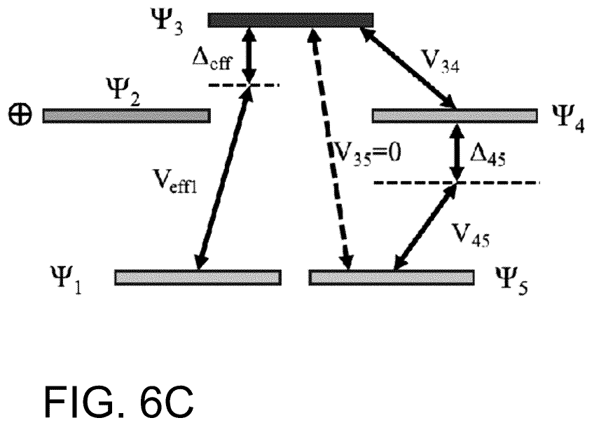

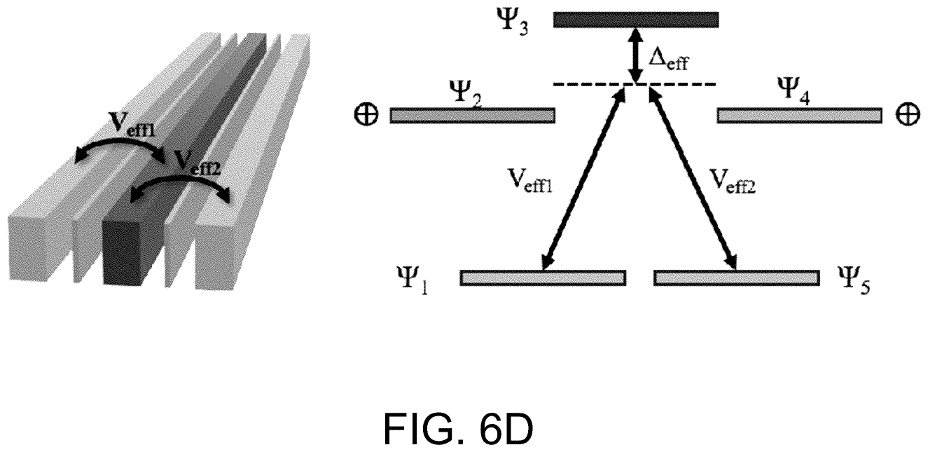

FIGS. 6A through 6D are AE schemes depicted in atomic physics and optical waveguides for an example OR gate. FIG. 6A is representative of input-output XY=00, FIG. 6B is representative of input-output XY=01, FIG. 6C is representative of input-output XY=10, and FIG. 6D is representative of input-output XY=11.

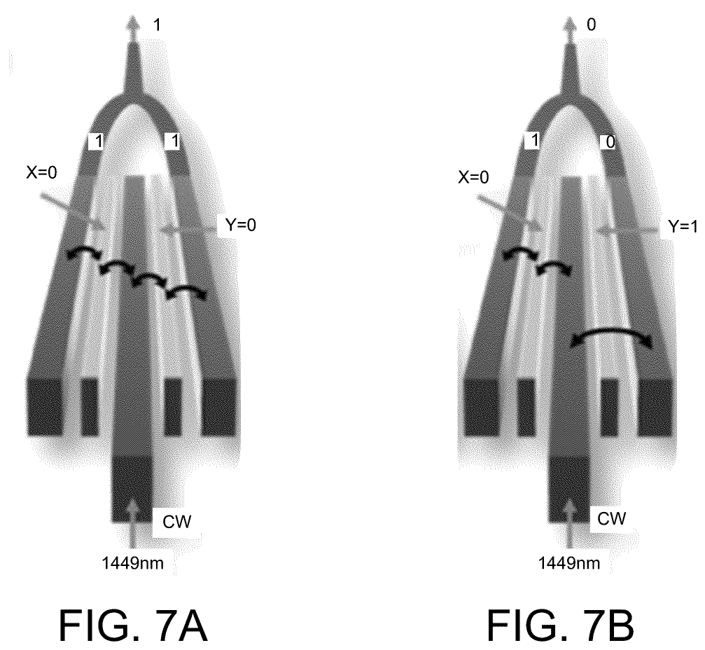

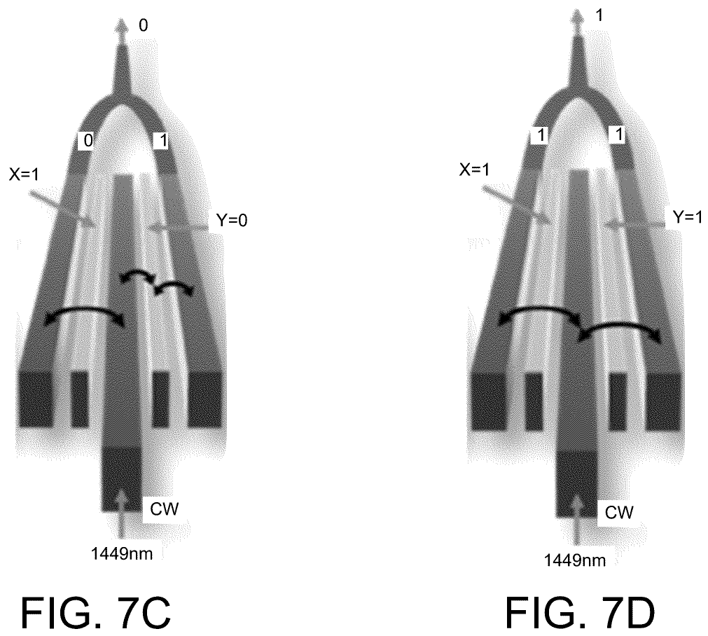

FIGS. 7A through 7D are diagrams of an example XNOR PLG in accordance with some embodiments of the present disclosure. As depicted in FIGS. 7A through 7D, a PLG is configured as a XNOR gate via a center waveguide (e.g., in a fashion corresponding to SI waveguide 406) that is provided with a CW comprising a 1449 nm wavelength. The two waveguides (e.g., in a fashion corresponding to Si waveguides 404 and 408) adjacent to the center waveguide may be provided with X and Y inputs, respectively, and the outer waveguides (e.g., in a fashion corresponding to Si waveguides 402 and 410) may provide X and Y outputs that respectively correspond to the X and Y inputs. The X and Y outputs from the outer waveguides may be merged (e.g., via a Y-coupler) to generate an output of the XNOR PLG.

FIG. 7A depicts inputs of X=0 and Y=0 into the waveguides adjacent to the center waveguide that cause outputs of ‘11’ and combined to provide a XNOR PLG output of 1.

FIG. 7B depicts inputs of X=0 and Y=1 into the waveguides adjacent to the center waveguide that cause outputs of ‘10’ and combined to provide a XNOR PLG output of 0.

FIG. 7C depicts inputs of X=1 and Y=0 into the waveguides adjacent to the center waveguide that cause outputs of ‘01’ and combined to provide a XNOR PLG output of 0.

FIG. 7D depicts inputs of X=1 and Y=1 into the waveguides adjacent to the center waveguide that cause outputs of ‘11’ and combined to provide a XNOR PLG output of 1.

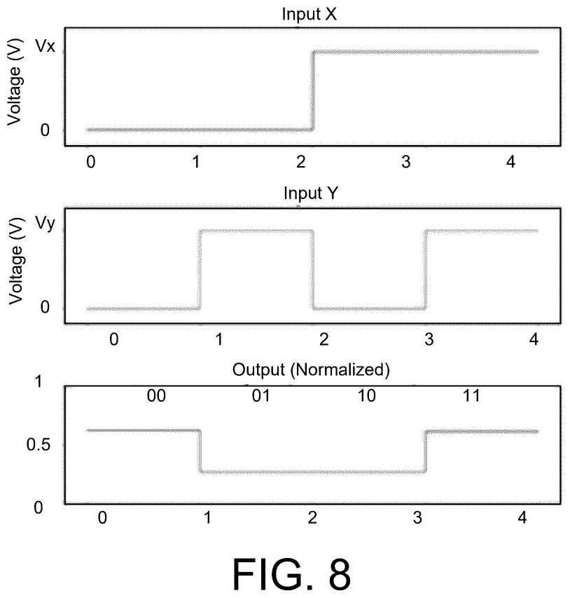

FIG. 8 example input and output signals of an example XNOR PLG implementation in accordance with some embodiments of the present disclosure. The signals depicted in FIG. 8 are representative of a PLG configured as an XNOR logic gate by providing a center waveguide, as described with reference to FIGS. 7A through 7D, with a CW comprising a wavelength (e.g., 1449 nm) that corresponds to XNOR gate functionality.

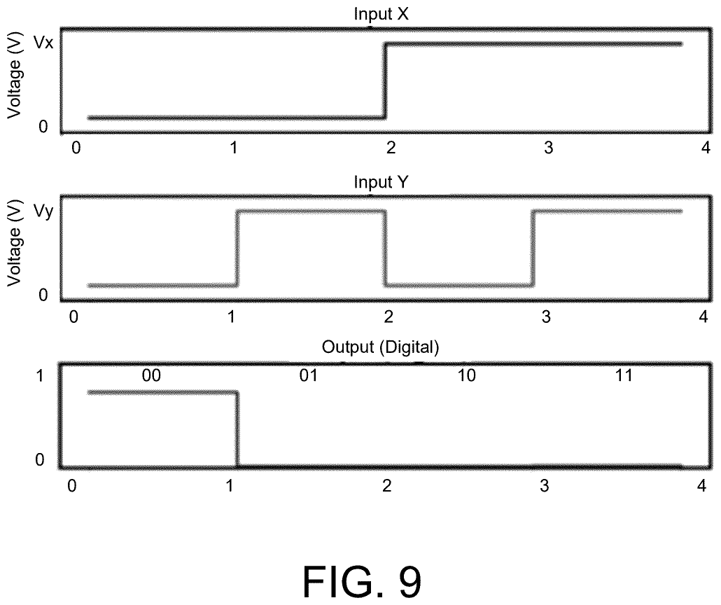

FIG. 9 are example input and output signals of an example NOR PLG implementation in accordance with some embodiments of the present disclosure. The signals depicted in FIG. 9 are representative of a PLG configured as a NOR logic gate by providing a center waveguide with a CW comprising a wavelength that corresponds to NOR gate functionality.

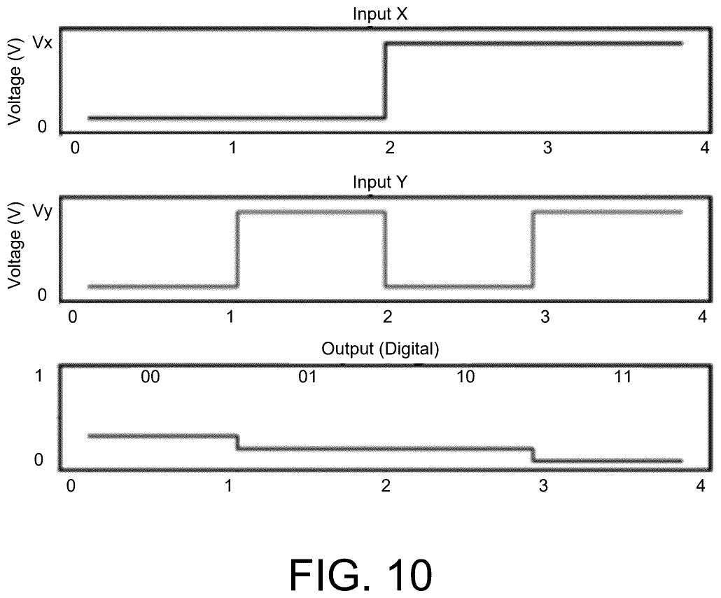

FIG. 10 are example input and output signals of an example NAND PLG implementation in accordance with some embodiments of the present disclosure. The signals depicted in FIG. 10 are representative of a PLG configured as a NAND logic gate by providing a center waveguide with a CW comprising a wavelength that corresponds to NAND gate functionality.

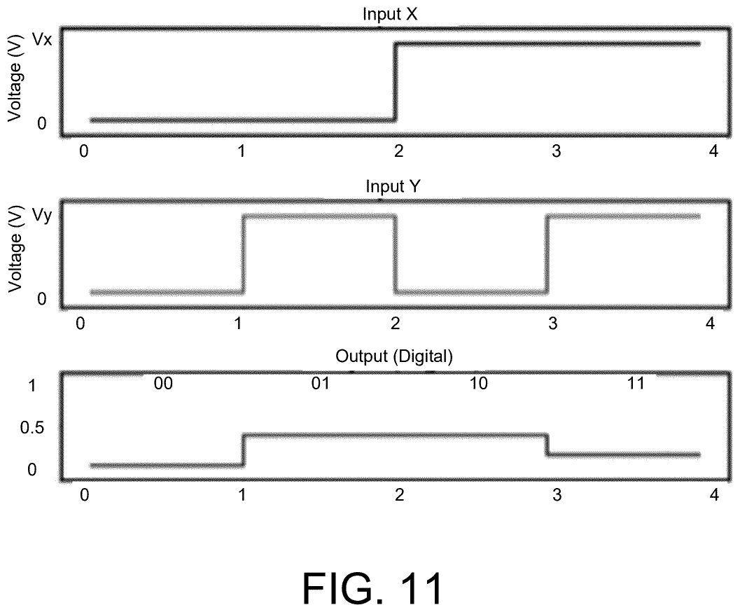

FIG. 11 are example input and output signals of an example XOR PLG implementation in accordance with some embodiments of the present disclosure. The signals depicted in FIG. 11 are representative of a PLG configured as a XOR logic gate by providing a center waveguide with a CW comprising a wavelength that corresponds to XOR gate functionality.

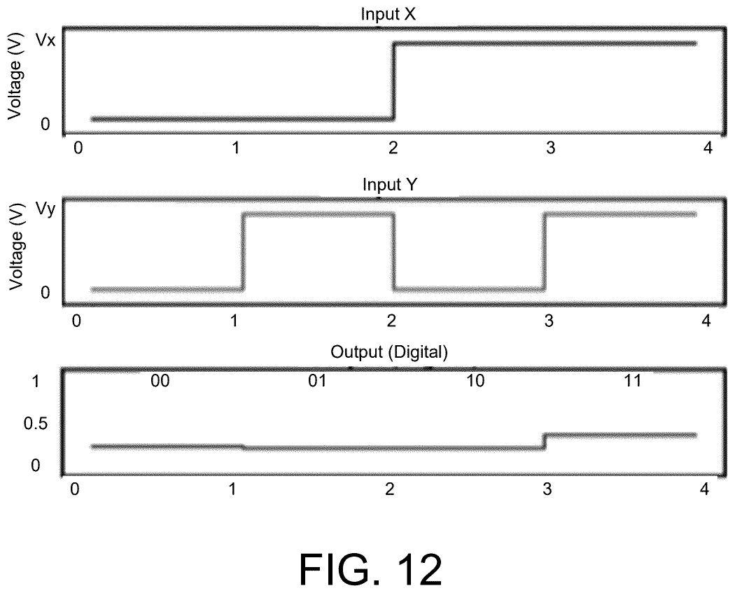

FIG. 12 are example input and output signals of an example AND PLG implementation in accordance with some embodiments of the present disclosure. The signals depicted in FIG. 12 are representative of a PLG configured as a AND logic gate by providing a center waveguide with a CW comprising a wavelength that corresponds to AND gate functionality.

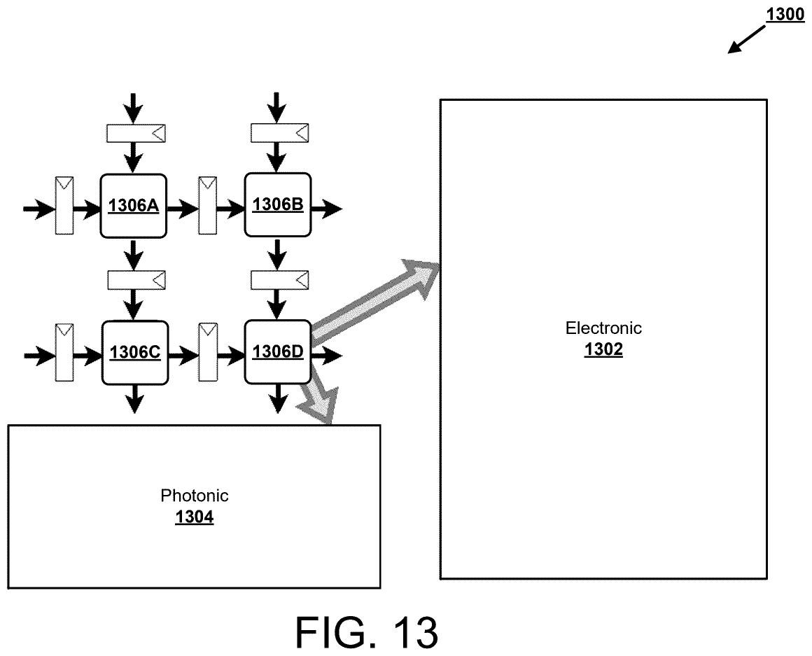

FIG. 13 is a schematic diagram of an example systolic array 1300 in accordance with some embodiments of the present disclosure. The systolic array 1300 may be configured to perform matrix-matrix multiplication and comprises a plurality of processing elements 1306A, 1306B, 1306C, and 1306D. Any one of the processing elements 1306A, 1306B, 1306C, and 1306D may be used for electronic-based machine learning acceleration 1302 and/or photonic-based machine learning acceleration 1304.

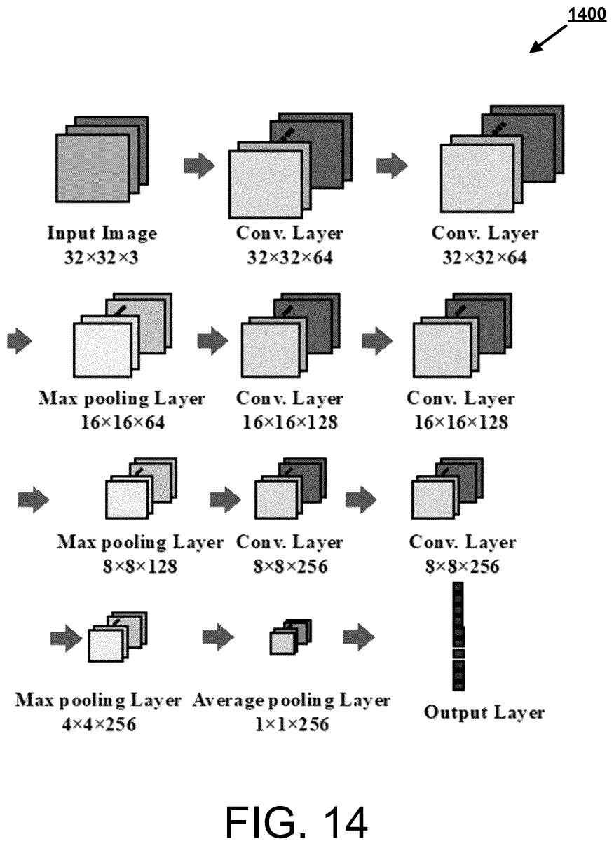

FIG. 14 is an architectural and layer information diagram for an example XNOR-Net neural network 1400. The XNOR-Net neural network 1400 comprises a binary neural network that may transform neural computations using efficient binary operations, thereby reducing memory and processing needs. The XNOR-Net neural network 1400 comprises a visual geometry group (VGG)-like structure of six convolutional layers with a total of 448 3×3 filters, three max pooling layers, one average pooling layer, and one fully-connected layer with 256 neurons. The speed and parallelism of the disclosed ITO-based photonic gates may be leveraged to implement the XNOR-Net neural network 1400.

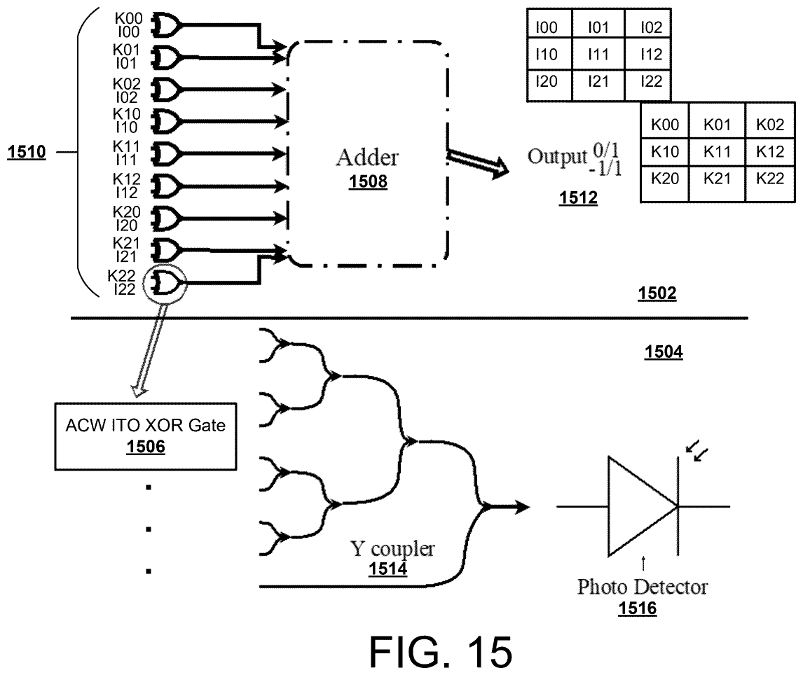

FIG. 15 is a comparison of example components for realizing a XNOR-Net in electronic and photonic domains in accordance with some embodiments of the present disclosure. An electronic implementation 1502 comprises one or more full adders 1508 that are provided with corresponding inputs from a plurality of digital XNOR gates 1510 to generate a final summation output 1512. By contrast, a photonic implementation 1504 comprises a plurality of ACW ITO-based XOR gates 1506 (e.g., PLGs) that provides the functionality of the digital XNOR gates. The photonic implementation 1504 further comprises one or more Y-couplers 1514 that combine output (e.g., optical power signals) from the plurality of ACW ITO-based XOR gates 1506 into an optical output signal that is provided to one or more photodetectors 1516 for distinguishing an output result corresponding to a specific tile (e.g., processing element) of a convolution operation.

### Conclusion

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A photonic gate system comprising:
a center waveguide that is provided with a continuous wave input;
a first electrically controlled plasmonic waveguide configured on a first opposing side that is adjacent to the center waveguide;
a second electrically controlled plasmonic waveguide configured on a second opposing side that is adjacent to the center waveguide;
a first outer waveguide configured adjacent to the first electrically controlled plasmonic waveguide; and
a second outer waveguide configured adjacent to the second electrically controlled plasmonic waveguide.

2. The photonic gate system of claim 1, wherein the first electrically controlled plasmonic waveguide is configured to receive a first signal input and the second electrically controlled plasmonic waveguide is configured to receive a second signal input.

3. The photonic gate system of claim 2, wherein the first outer waveguide is configured to provide a first output that corresponds to the first signal input and the second outer waveguide is configured to provide a second output that corresponds to the second signal input.

4. The photonic gate system of claim 1 further comprising a coupler that is coupled to the first outer waveguide and the second outer waveguide.

5. The photonic gate system of claim 4, wherein the coupler is configured to generate a data signal output based on (i) a first output that corresponds to the first outer waveguide and (ii) a second output that corresponds to the second outer waveguide.

6. The photonic gate system of claim 5, wherein the data signal output comprises a matrix multiplication result output corresponding to a processing element of a systolic array.

7. The photonic gate system of claim 1, wherein the first electrically controlled plasmonic waveguide and the second electrically controlled plasmonic waveguide further comprise indium tin oxide or silicon dioxide that is coupled with gold or titanium padding.

8. The photonic gate system of claim 1, wherein a wavelength of the continuous wave input is configured to control coupling between (i) the first electrically controlled plasmonic waveguide and a first outer waveguide or (ii) the second electrically controlled plasmonic waveguide and the second outer waveguide.

9. The photonic gate system of claim 1, wherein the continuous wave input comprises a wavelength that corresponds to a logic gate operation.

10. The photonic gate system of claim 9, wherein the logic gate operation comprises AND, NAND, NOR, OR, XOR, or XNOR.
